(19) United States
(12) Patent Application Publication
(10) Pub. No.: US 2005/0131817 A1
(43) Pub. Date: Jun. 16, 2005

(54) Payment installation from a prepaid card

(76) Inventor: Alain Chemla, Paris (FR)

Correspondence Address: WENDEROTH, LIND & PONACK, L.L.P., 2033 K STREET N. W., SUITE 800, WASHINGTON, DC, 20006-1021, US

(21) Appl. No.: 10/492,215

(22) PCT Filed: Mar. 7, 2003
(86) PCT No.: PCT/FR03/00750

(30) Foreign Application Priority Data
Mar. 7, 2002 (FR) 02/2905

(51) Int. Cl. G06F 17/60

(52) U.S. Cl. 705/40

(57) ABSTRACT

The payment installation (10) comprises a payment card (12) comprising means for storing an available amount (M [symbol] ) expressed in a first currency ( [symbol] ) and a payment terminal (14) adapted to read the available amount (M [symbol] ), means for calculating a new available amount, and means (16) for saving the new available amount. The payment terminal (14) comprises means (18, 20) for fixing an amount (D_{$}) to be debited expressed in a second monetary unit ($). The installation (10) comprises means (18) for converting the amount (D_{$}) to be debited into a converted amount (C [symbol] ) to be debited expressed in the first currency ( [symbol] ). The means for calculating the new available amount are adapted to determine the new available amount by subtracting the converted amount (C [symbol] ) to be debited from said read available amount (M [symbol] ).

The present invention relates to a payment installation comprising a payment card for a first monetary unit including means for storing an available amount expressed in the first monetary unit and a payment terminal equipped with means for reading said available amount expressed in the first monetary unit stored in said card, means for calculating a new available amount, and means for saving in the payment card for the first monetary unit the new available amount expressed in the first monetary unit.

Using a rechargeable or non-rechargeable payment card to pay for goods and services is known in the art. The payment card includes means for storing an available amount expressed in a particular monetary unit such as a national currency.

To purchase an item, the payment card is inserted into a reader, which determines the available amount stored in the card. The available amount is decremented by the amount to be paid and the new available amount is saved in the card.

Existing installations allow payment by a payment card provided that the monetary unit used for the amount available on the card and the monetary unit used for the amount to be paid are the same.

Thus a payment card of the above kind can be used only in a country whose currency corresponds to the monetary unit used for the amount available on the card.

An object of the invention is to propose a payment installation that enables the same card to be used in different countries having different monetary units.

To this end, the invention consists in a payment installation of the type specified above characterized in that the payment terminal includes means for fixing an amount expressed in a second monetary unit different from the first monetary unit, in that the installation includes means for converting the amount to be debited expressed in the second monetary unit into a converted amount to be debited expressed in the first monetary unit, and in that the means for calculating the new available amount expressed in the first monetary unit are adapted to determine the new available amount by subtracting the converted amount to be debited expressed in the first monetary unit from said read available amount expressed in the first monetary unit.

Particular embodiments of the installation have one or more of the following features:
said conversion means are integrated into the payment terminal and comprise means for storing an exchange rate and means for calculating the converted amount to be debited from the amount to be debited expressed in the second monetary unit and the stored exchange rate;
said conversion means comprise remote conversion data processing means connected to the payment terminal by a collective telecommunications network, the payment terminal and the remote conversion data processing means comprise means for exchanging the amount to be debited expressed in the second monetary unit and the converted amount to be debited expressed in the first monetary unit via said collective telecommunications network, and the remote conversion data processing means comprise means for storing an exchange rate and means for calculating the converted amount to be debited from the amount to be debited expressed in the second monetary unit and the stored exchange rate;
the payment terminal includes means for fixing an amount to be debited expressed in the first monetary unit and the means for calculating the new available amount are adapted to calculate the new available amount by subtracting the amount to be debited expressed in the first monetary unit from said read available amount expressed in the first monetary unit; and
the installation comprises a payment card for a second monetary unit comprising means for storing an available amount expressed in the second monetary unit, and the payment terminal has means for reading said available amount expressed in the second monetary unit, means for calculating a new available amount by subtracting the amount to be debited expressed in the second monetary unit from the read available amount expressed in the second monetary unit, and means for saving in the payment card for the second monetary unit the new available amount expressed in the second monetary unit.

The invention will be better understood on reading the following description, which is given by way of example only and with reference to the drawings, in which:

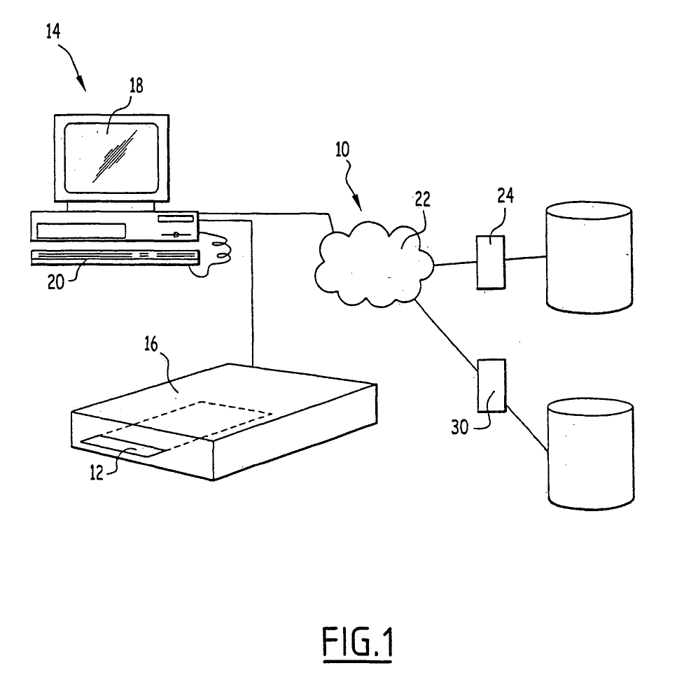

FIG. 1 is a diagrammatic view of a payment installation of the invention;

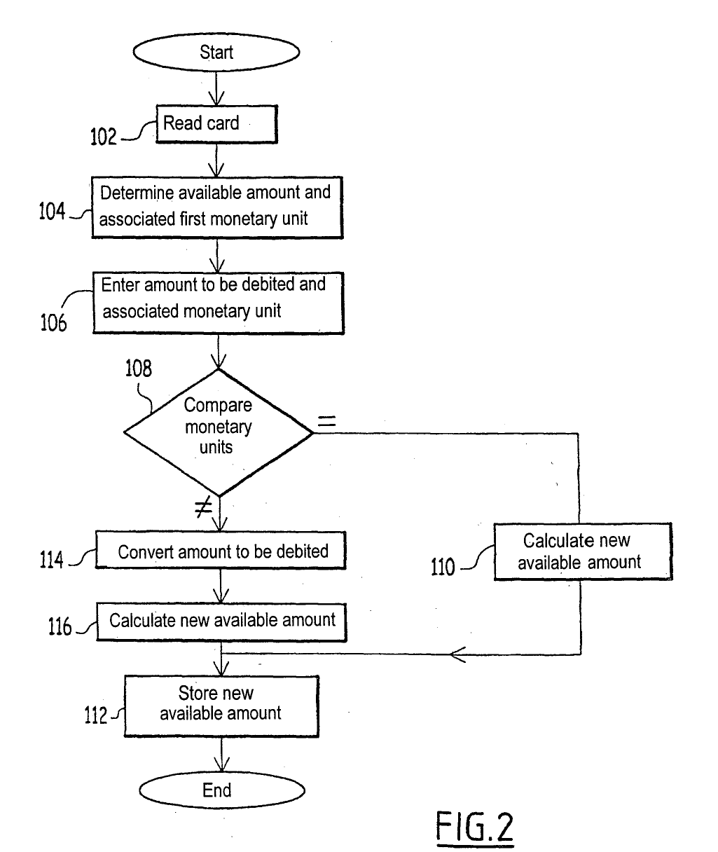

FIG. 2 is a flowchart explaining an algorithm used by a payment terminal of the installation of the invention; and

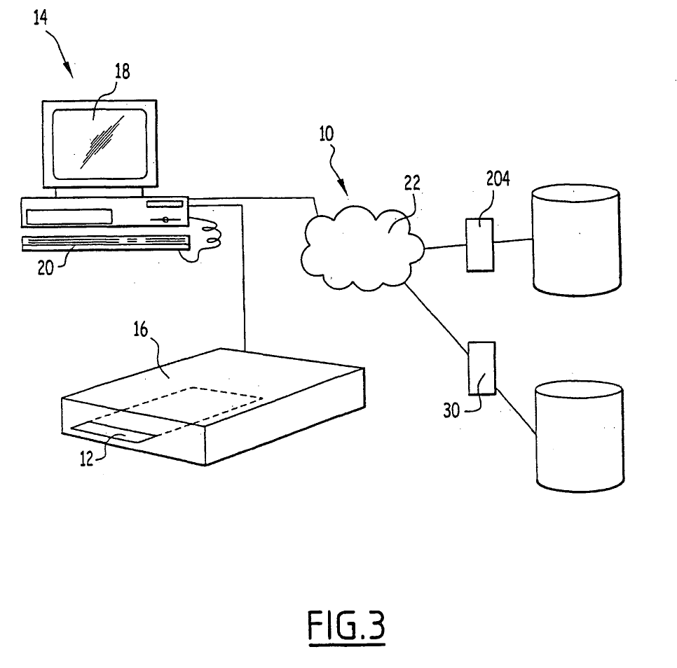

FIG. 3 is a diagrammatic view of a different embodiment of a payment installation of the invention.

FIG. 1 shows a payment installation 10 using disposable or rechargeable prepaid payment cards 12.

To use this kind of installation, potential customers must have a payment card for a predetermined monetary unit, such as the dollar or the euro. Each payment card 12 includes rewritable memory for storing an available amount expressed in the predetermined monetary unit.

The available amount is expressed in the local currency of the cardholder, depending on nationality.

The cards are purchased from a distribution network or are recharged subject to payment of an amount equivalent to the available amount originally stored in the card.

The payment installation 10 includes a payment terminal 14 for each trader accepting the payment cards. Each payment terminal is equipped with a card reader 16 able to read the available amount stored in the memory of a card and the monetary unit in which the available amount is expressed.

The reader 16 can read dollar cards and euro cards and can write a new available amount into the memory of the card following a payment.

The reader 16 is connected to a data processing unit 18 adapted to execute the algorithm shown in FIG. 2.

The data processing unit comprises a microcomputer controlled by suitable software, for example.

The data processing unit 18 may be the control unit of a cash dispenser adapted to supply to the cardholder a predetermined amount in coins and/or bills, for example, subject to reduction of the available amount stored in the card by an amount corresponding to the amount delivered in coins and/or bills.

The data processing unit 18 includes a memory for storing a conversion rate from a first monetary unit to a second monetary unit, such as an exchange rate from euros to dollars and/or from dollars to euros.

The data processing unit 18 further includes means 20 such as a keypad for entering and setting an amount to be debited and for identifying the monetary unit in which the amount to be debited is expressed. Thus the input means 20 are used to input an amount in dollars or euros to be debited to the client to pay the requested price.

In a first embodiment, shown in FIG. 1, the data processing unit 18 is connected via a collective telecommunications network 22 to a server 24 adapted to communicate the applicable exchange rates periodically to the data processing unit 18, to be stored in its memory. The network 22 is a UMTS or GSM wireless telecommunications network, for example.

Furthermore, and as is known in the art, the data processing unit 18 of the payment terminal is connected to a data processing system 30 of the organization that distributes the payment cards, to enable the payment terminal 14 to send payment information to the data processing system 30 of the management organization. The management organization makes the payment to the trader on the basis of the payment information.

The payment installation operates in the following manner.

The exchange rates stored in the data processing unit 18 are periodically updated on the basis of information communicated by the server 24 to the payment terminal via the network 22.

The exchange rates are calculated from official exchange rates between the currencies concerned at the date of the payment operation, and are advantageously higher than the official currency exchange rates, the difference corresponding to a commission received by the trader and/or the management organization.

To make the payment, the cardholder inserts the card into the reader 12 in a step 102. The data processing unit 18 determines the available amount M [symbol] and the monetary unit in which that available amount is expressed in a step 104. This first monetary unit is assumed to be the euro in the present example.

In a step 106, the trader enters the amount to be debited and the monetary unit in which the amount to be debited is expressed.

In the case of a cash dispenser, the amount to be debited is fixed and corresponds to the amount delivered by the dispenser, possibly increased by the amount of a commission.

In a step 108, a test is carried out to compare the monetary unit in which the available amount is expressed and the monetary unit in which the amount to be debited is expressed.

If the two monetary units are the same, the amount to be debited being expressed in euros in the present example, the new available amount M [symbol] -D [symbol] is calculated in a step 110, where D [symbol] is the amount in euros to be debited. The new available amount M [symbol] -D [symbol] is stored in the card in a step 112.

In parallel with this, or subsequently, the central unit 18 communicates the debited amount D [symbol] to the data processing system 30 of the management organization, for payment of the trader.

A step 114 is executed if the test executed in the step 108 determines that the monetary unit in which the available amount is expressed and the monetary unit in which the amount to be debited is expressed are different. In the present example, the amount D_{$} to be debited is expressed in dollars.

In the step 114, the amount D_{$} to be debited expressed in dollars is converted into an amount to be debited expressed in the monetary unit in which the available amount stored in the card is expressed, namely the euro in the present example.

The exchange rate stored in the data processing unit 18 is used for this purpose.

In a step 116 the converted amount C [symbol] to be debited is subtracted from the available amount M [symbol] stored in the card.

After this calculation, the new available amount M [symbol] -C [symbol] is stored in the card in the step 112.

Clearly, with a payment installation of this kind, a trader can effect a transaction regardless of the monetary unit in which the available amount is expressed and regardless of the monetary unit in which the amount to be debited is expressed, the available amount stored in the card being reduced by the counterpart amount expressed in the monetary unit specific to the payment card of the amount to be debited expressed in a different monetary unit.

FIG. 3 shows a different embodiment of the installation. Items in this figure identical or analogous to those in FIG. 1 are designated by the same reference numbers.

The data processing unit 18 includes means for sending to remote conversion data processing means 204 via a collective telecommunications network 22. The remote conversion data processing means 204 include means for storing an exchange rate that corresponds to the official exchange rate between the monetary units concerned, where applicable increased by a commission.

The remote conversion data processing means 204 are adapted, on receiving an amount to be converted, to calculate a converted amount and to send this back to the data processing unit 18 via the telecommunications network 22.

In this embodiment the conversion of the amount to be debited expressed in a monetary unit different from that of the amount to be debited, as effected in the step 114, includes a first step in which the data processing unit 18 sends the remote conversion data processing means 204 the amount to be debited. The remote conversion data processing means effect the conversion using the amount to be debited it has received and the stored exchange rate, after which the converted amount to be debited is sent back to the data processing unit 18.

The algorithm described here assumes that the available amount is expressed in euros. However, the same algorithm is used by the data processing unit 18 if the available amount stored in the card is expressed in dollars.

What is more, the above example considers only two currencies for simplicity. The invention may be implemented with three or more different currencies, however.

The monetary unit used for the available amount stored in the payment card may be a dedicated monetary unit not corresponding to any particular currency. The exchange rates used then correspond to defined exchange rates between the dedicated monetary unit for the payment card and various national currencies.

1-5. (canceled)

6. A payment installation (10) comprising a payment card (12) for a first monetary unit ( [symbol] ) including means for storing an available amount (M [symbol] ) expressed in the first monetary unit ( [symbol] ) and a payment terminal (14) equipped with means (16) for reading said available amount (M [symbol] ) expressed in the first monetary unit ( [symbol] ) stored in said card (12), means for calculating a new available amount, and means (16) for saving in the payment card (12) for the first monetary unit ( [symbol] ) the new available amount expressed in the first monetary unit ( [symbol] ), wherein the payment terminal (14) includes means (18, 20) for fixing an amount (D_{$}) to be debited expressed in a second monetary unit ($) different from the first monetary unit ( [symbol] ), wherein the installation (10) includes means (18; 204) for converting the amount (D_{$}) to be debited expressed in the second monetary unit ($) into a converted amount (C [symbol] ) to be debited expressed in the first monetary unit ( [symbol] ), and wherein the means for calculating the new available amount expressed in the first monetary unit ( [symbol] ) are adapted to determine the new available amount by subtracting the converted amount to be debited (C [symbol] ) expressed in the first monetary unit ( [symbol] ) from said read available amount (M [symbol] ) expressed in the first monetary unit ( [symbol] ).

7. A payment installation according to claim 6, wherein said conversion means (18) are integrated into the payment terminal (14) and comprise means for storing an exchange rate and means for calculating the converted amount (C [symbol] ) to be debited from the amount (D_{$}) to be debited expressed in the second monetary unit ($) and the stored exchange rate.

8. A payment installation according to claim 6, wherein said conversion means comprise remote conversion data processing means (204) connected to the payment terminal (14) by a collective tele-communications network (22) and the payment terminal (14), the remote conversion data processing means (204) comprise means for exchanging the amount (D_{$}) to be debited expressed in the second monetary unit ($) and the converted amount (C [symbol] ) to be debited expressed in the first monetary unit ( [symbol] ) via said collective tele-communications network (22), and the remote conversion data processing means (204) comprise means for storing an exchange rate and means for calculating the converted amount (C [symbol] ) to be debited from the amount to be debited (D_{$}) expressed in the second monetary unit($) and the stored exchange rate.

9. A payment installation according to claim 6, wherein the payment terminal (14) includes means (20) for fixing an amount (D [symbol] ) to be debited expressed in the first monetary unit ( [symbol] ) and the means for calculating the new available amount are adapted to calculate the new available amount by subtracting the amount (D [symbol] ) to be debited expressed in the first monetary unit ( [symbol] ) from said read available amount (M [symbol] ) expressed in the first monetary unit ( [symbol] ).

10. A payment installation according to claim 6, comprising a payment card (12) for a second monetary unit ($) comprising means for storing an available amount (M [symbol] ) expressed in the second monetary unit ($), and wherein the payment terminal (14) has means (16) for reading said available amount (M_{$}) expressed in the second monetary unit ($), means for calculating a new available amount by subtracting the amount (D_{$}) to be debited expressed in the second monetary unit ($) from the read available amount (M_{$}) expressed in the second monetary unit ($), and means for saving in the payment card (12) for the second monetary unit the new available amount expressed in the second monetary unit ($).
